(19) United States
(12) Patent Application Publication
(10) Pub. No.: US 2004/0069080 A1
(43) Pub. Date: Apr. 15, 2004

(54) Apparatus for conversion of centrifugal force

(76) Inventor: Simeon Sordjan JR., Ridgewood, NY (US)

Correspondence Address: Jennifer Meredith, Empire State Building, Suite 7720, 350 Fifth Avenue, New York, NY, 10018, US

(21) Appl. No.: 10/648,062

(22) Filed: Aug. 25, 2003

Related U.S. Application Data
(60) Provisional application No. 60/405,733, filed on Aug. 26, 2002.

(51) Int. Cl. F16H 33/20

(52) U.S. Cl. 74/84 S

(57) ABSTRACT

The present invention provides systems and methods to propulsion apparatus, and particularly to propulsion devices using unbalanced centrifugal force to propel a vehicle in a unidirectional motion. According to one embodiment, a device for conversion of centrifugal force to linear force and motion is disclosed, comprising: a first gear rotatably fixed to a first arm and having a first connecting bar rotatably attached to and abutting the inner side of the first gear and a second connecting bar rotatably attached to and abutting the outer side of the first gear; a second gear in opposite rotational communication with the first gear and weighted along an outer edge and rotatably attached to and abutting the first connecting bar and the second connecting bar; and a first drive means for translating centrifugal motion of the first gear to unidirectional motion.

This patent was originally filed as Provisional Patent Application No. 60/405,733 filed Aug. 26, 2002 and titled, “SORDJAN.”

### BACKGROUND OF THE INVENTION

The present invention generally relates to propulsion apparatus, and particularly to propulsion devices using unbalanced centrifugal force to propel a vehicle in a unidirectional motion.

Various centrifugal propulsion devices are known within the art. By way of example, U.S. Pat. No. 5,937,698 issued to Kunz discloses a propulsion device which employs a belt driven rotor with an aperture larger than the shaft around which it revolves to create a net centrifugal force. According to Newton's Law force is produced as a result of an object which is constantly changing direction. Since changing direction constitutes acceleration, by Newton's law F=MA, a resulting force is produced. Centrifugal force is also directly proportional to the mass of the object or the radius of the circle through which the mass is traveling. This '698 patent discloses the use of net centrifugal force to propel the base of the system. However, the '698 device requires a certain angular speed to work efficiently, providing a device which is not effective at low rpm's.

U.S. Pat. No. 4,991,453 issued to Mason, concentrates a centrifugal force by rotating arms at the end which are perpendicularly rotating weighted armlets. The rotating weighted armlets cause variations in the centripetal force resulting in a net force vector. Although relatively simple compared to some other centrifugal force generators, this is still needlessly complex, incorporating multiple rotating members.

U.S. Pat. No. 4,238,968 issued to Cook utilizes two counter-rotating arms about a common axle for generating linear motion. One arm contains a mass, which is splitable as well as transferable to the other arm and back at intervals of one hundred and eighty (180) degrees of rotation. As in the '453 patent, the '968 device is also needlessly complex.

Accordingly, that is not complex and efficiently generates unidirectional force from centrifugal or rotational forces and that doesn't transfer masses from one rotating member to the other. As such, the device may be used to propel wheeled vehicles, watercraft, aircraft or spacecraft.

### SUMMARY OF THE INVENTION

The present invention provides a device for the conversion of centrifugal force to linear force and motion to propel wheel vehicle, watercraft, aircraft or spacecraft. It is intended to provide a simple, gasless, lightweight method of propulsion.

According to one embodiment, a device for conversion of centrifugal force to linear force and motion is disclosed, the device comprising: a first gear rotatably fixed to a first arm and having a first connecting bar rotatably attached to and abutting the inner side of the first gear and a second connecting bar rotatably attached to and abutting the outer side of the first gear; a second gear in opposite rotational communication with the first gear and weighted along an outer edge and is rotatably attached to and abutting the first connecting bar and the second connecting bar; and a first drive means for translating centrifugal motion of the first gear to unidirectional motion.

According to another embodiment, a device for conversion of centrifugal force to linear force and motion is disclosed, the device comprising: a first gear rotatably fixed to a first arm and having a first connecting bar rotatably attached to and abutting the inner side of the first gear; a second gear in opposite rotational communication with the first gear and weighted along an outer edge and is rotatably attached to and abutting the first connecting bar; and a first drive means for translating centrifugal motion of the first gear to unidirectional motion.

According to yet another embodiment, a device for conversion of centrifugal force to linear force and motion is disclosed, the device comprising: a first gear rotatably fixed to a first arm and having a first connecting bar rotatably attached to and abutting the inner side of the first gear and a second connecting bar rotatably attached to and abutting the outer side of the first gear; a second gear in opposite rotational communication with the first gear and weighted along an outer edge and is rotatably attached to and abutting the first connecting bar and the second connecting bar; a third gear in opposite rotational communication with the first gear and weighted along the outer edge which rotates about the first gear and being rotatably attached to the first connecting bar and the second connecting bar one hundred and eighty (180) degrees from the second gear; a fourth gear in opposite rotational communication with the first gear, being ninety (90) degrees from the second gear and weighted along the outer edge, and being rotatably attached to the third connecting bar; a fifth gear in opposite rotational communication with the first gear, being 270 degrees from the second gear and weighted along the outer edge, and being rotatably attached to the third connecting bar; a third connecting bar rotatably attached to the first gear, the fourth gear and the fifth gear; and a first drive means for translating centrifugal motion of the first gear to unidirectional motion.

These and other features, aspects and advantages of the present invention will become better understood with reference to the following drawings, description and claims.

### BRIEF DESCRIPTION OF THE DRAWINGS

FIG. 1A is a side view according to the present invention;

FIG. 1B is a front view according to the present invention;

FIG. 1C is a top view according to the present invention;

FIG. 2A is a side view according to the present invention;

FIG. 2B is a front view according to the present invention;

FIG. 3A is a side view according to the present invention; and

FIG. 3B is a front view according to the present invention;

### DETAILED DESCRIPTION OF THE INVENTION

Turning now descriptively to the drawings, wherein similar reference numbers denote similar elements throughout the several views, the attached figures illustrate systems and methods according to the present invention.

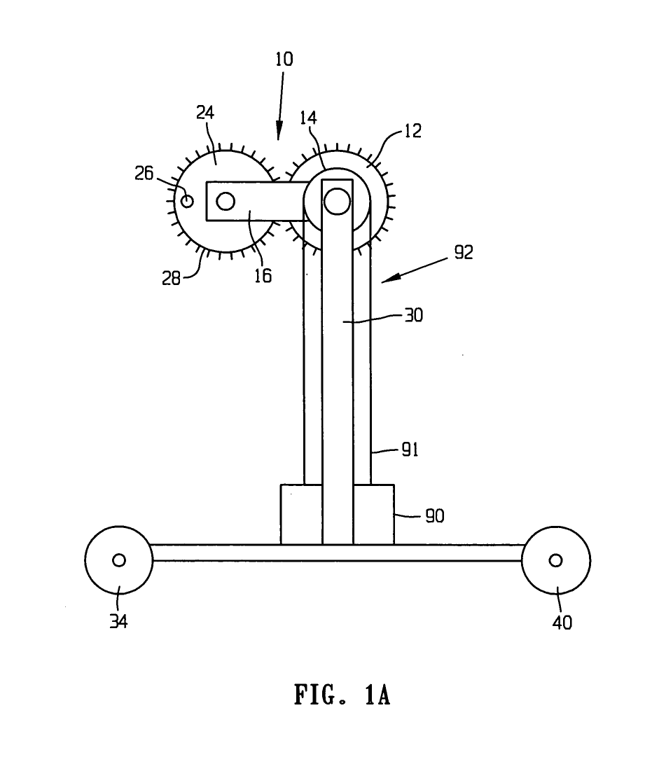

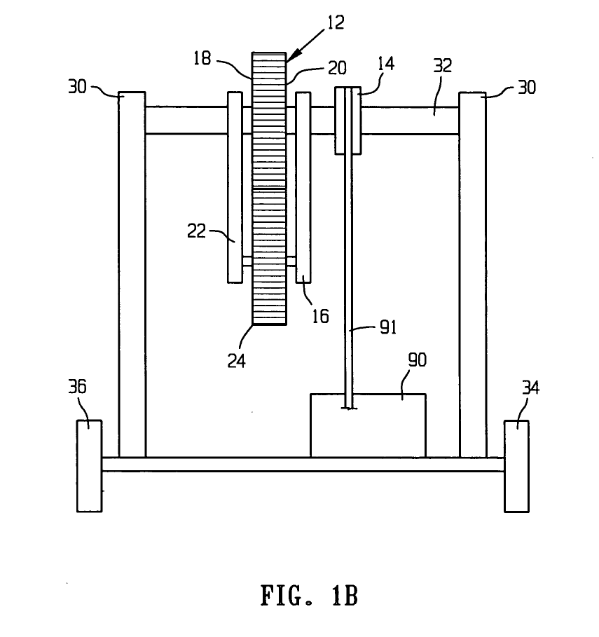

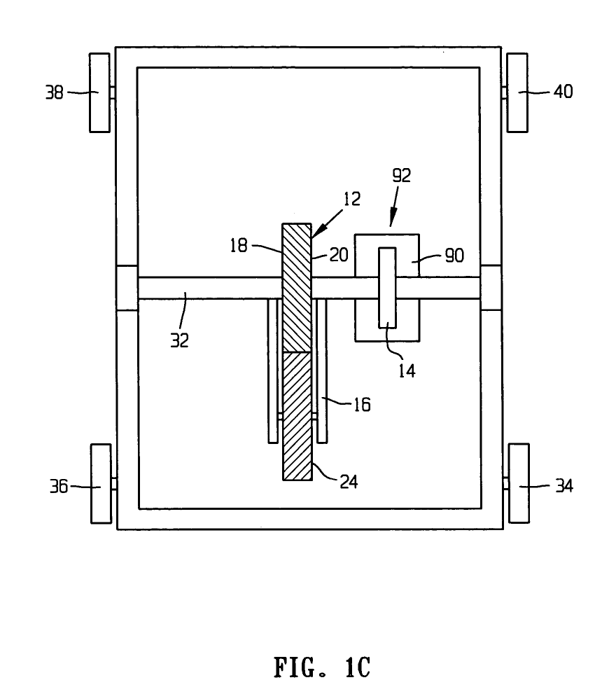

FIGS. 1A, 1B and 1C depict a device 10 for conversion of centrifugal force to linear force and motion. The device 10 having a first gear 12 fixed to a first arm 14 and having a first connecting bar 16 rotatably attached to and abutting the inner side 20 of the first gear 12 and a second connecting bar 22 rotatably attached to and abutting the outer side 18 of the first gear 12. As shown, there is a first arm 14 and a supporting bar 32. A second gear 24 may be in opposite rotational communication with the first gear 12 and weighted (e.g. by weight 26) along an outer edge 28 and rotatably attached to and abutting the first connecting bar 16 and second connecting bar 22. The term opposite rotational communication may be defined as being in contact, such that when one gear turns, the other gear turns in the opposite direction. For example, if the first gear 12 turns clockwise, the second gear 24 would rotate counterclockwise. As shown, the first drive means 92 may be a motor 90 in communication with a chain, band, rope, belt 91 or any equivalent thereof. The belt 91 turns translation gear 14 which in turn causes first connecting bar 16 to turn and the attached second gear 24. The first drive means 92 may start the motion of the first connecting bar 16 which in turn causes the second gear 24 to rotate about the first gear 12. The centrifugal force causes a net force vector causing linear motion. Movement will occur when the net force vector overcomes all opposing forces, causing the wheels 34, 36, 38 and 40 to turn. Opposing forces may include friction of the wheels.

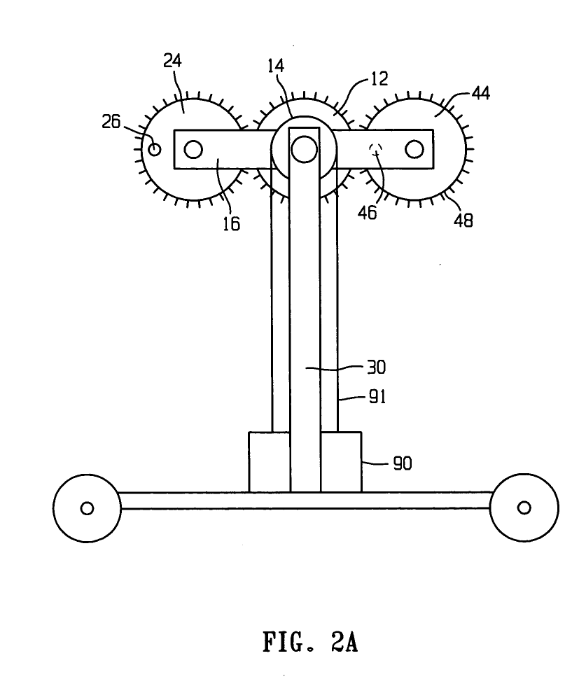

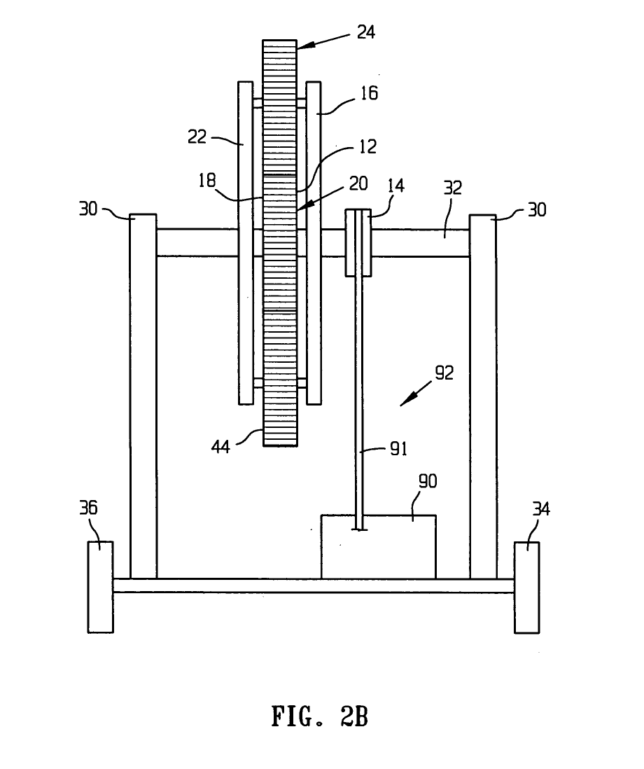

FIG. 2A depicts a device having a first gear 12 rotatably fixed to a first arm 14 and having a first connecting bar 16 rotatably attached to and abutting the inner side 20 of the first gear 12 and a second connecting bar 22 rotatably attached to and abutting the outer side 18 of the first gear 12. A second gear 24 may be in opposite rotational communication with the first gear 12 and weighted (e.g. by weight 26) along an outer edge 28 and rotatably attached to and abutting the first connecting bar 16 and second connecting bar 22; and a first drive means 92 for initiating centrifugal motion of the second gear gear 24. As shown, part of the first drive means 92 is a bar 32 that is in communication with the first gear 12 so that when the first gear 12 turns, bar 32 turns, which in turn turns wheels 34, 36, 38 and 40. FIGS. 2A and 2B are intended to depict that the first arm 14 may be closer to the gears than the drive means as shown, or further away (as in FIGS. 1A and 1B). As shown there may be a third gear 44 in opposite rotational communication with the first gear 12 and weighted 46 along the outer edge 48 which rotates about the first gear 12 and being rotatably attached to the first connecting bar 16 and the second connecting bar 22 one hundred and eighty degrees one hundred and eighty (180) degrees from the second gear 24.

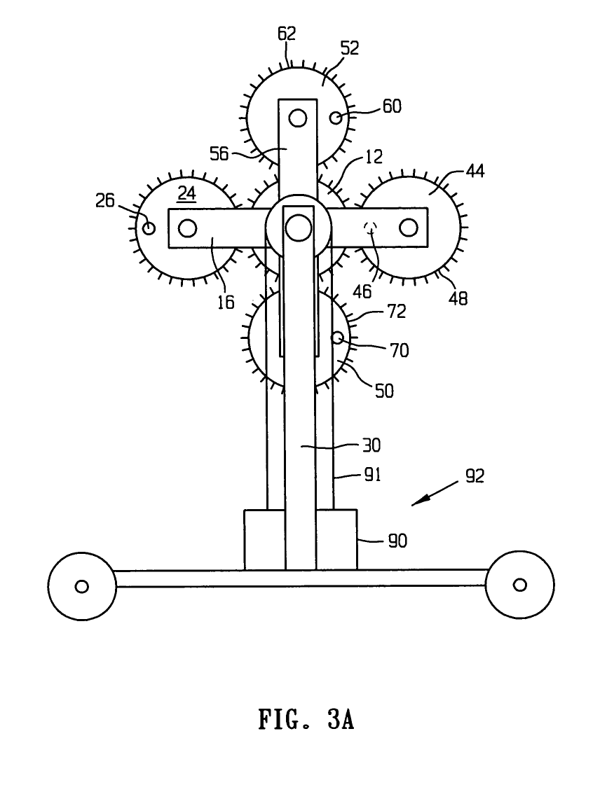

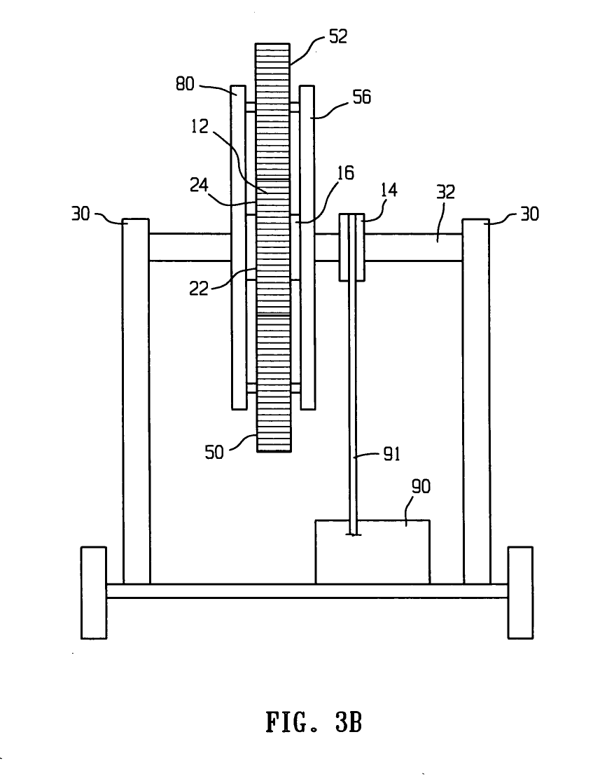

FIGS. 3A and 3B depict a device having a first gear 12 rotatably fixed to a first arm 14 and having a first connecting bar 16 rotatably attached to and abutting the inner side 20 of the first gear 12, second gear 24, third gear 44, fourth gear 52 and fifth gear 50. There is also a second connecting bar 22 (See FIG. 3B) rotatably attached to and abutting the outer side 18 of the first gear 12, second gear 24 and fifth gear 50. A second gear 24 may be in opposite rotational communication with the first gear 12 and weighted (e.g. by weight 26) along an outer edge 28 and rotatably attached to and abutting the first connecting bar 16 and second connecting bar 22. As shown, there is a third connecting bar 56 rotatably attached to the first gear 12. There is also a fourth gear 52 in opposite rotational communication with the first gear 12 and being ninety (90) degrees from the second gear 24 and weighted 26 along the outer edge. The fourth gear 52 is rotatably attached to the third connecting bar 56. Fourth connecting bar (not visible) is identical to the third connecting bar 56 on the opposite side. There is also a fifth gear 50 in opposite rotational communication with the first gear 12, being (270) degrees from the second gear 24 and weighted 70 along the outer edge 72, and being rotatably attached to the third connecting bar 56. As shown, there is a first drive means 92 for initiating motion of the second gear 24. As shown, the first drive means 92 causes translating gear 14 to turn, which causes first connecting bar 16 to turn, which causes second gear 24, third gear 44, fourth gear 52 and fifth gear 50 to turn. As discussed previously, the centrifugal force provides a net force vector that causes the wheels 34, 36, 38 and 40 to turn. Many different embodiments are envisioned and the first connecting bar 16 may be further away from the gears as shown or closer and even abutting the gears. As shown there may be a third gear 44 in opposite rotational communication with the first gear 12 and weighted 46 along the outer edge 48 which rotates about the first gear 12 and being rotatably attached to the first connecting bar 16 and the second connecting bar 22 one hundred and eighty (180) degrees from the second gear 24. The weight 46 is shown for the purposes of illustration, but would not be visible as the first connecting bar 16 would block visibility. There may also be a fourth connecting bar 80 (not visible) rotatably attached to the first gear 12 abutting an outer side of the third connecting bar 22. As previously, the first gear 12 may rotate in a clockwise direction and the second gear 24, third gear 44, fourth gear 52 and fifth gear 50 rotate in a counterclock wise direction. In each of the embodiments, there may be a second drive means 31 for translating centrifugal motion of the first gear 12 to unidirectional motion. It should be understood that the first drive means 92 and second drive means 31 may be separate or considered one drive means.

The figures as shown depict one set of gears. However, it is envisioned that more than one set of gears may be used. According to this embodiment, a first device and a second device would be attached to bar 32. They could be identical or have a different number of gears. Also, there may be different weight arrangement so as to counteract any unwanted force components.

It should be understood, of course, that the foregoing relates to preferred embodiments of the invention and that modifications may be made without departing from the spirit and scope of the invention as set forth in the following claims.

We claim:

1. A device for conversion of centrifugal force to linear force and motion, said device comprising:
a first gear fixed to a first arm and having a first connecting bar rotatably attached to and abutting the inner side of said first gear and a second connecting bar rotatably attached to and abutting the outer side of said first gear;
a second gear in opposite rotational communication with said first gear and weighted along an outer edge and is rotatably attached to and abutting said first connecting bar and said second connecting bar; and
a first drive means for translating centrifugal motion of said first gear to unidirectional motion.

2. A device as in claim 1, further comprising:
a third gear in opposite rotational communication with said first gear and weighted along the outer edge which rotates about said first gear and being rotatably attached to said first connecting bar and said second connecting bar one hundred and eighty (180) degrees from said second gear.

3. A device as in claim 1, further comprising:
a third gear in opposite rotational communication with said first gear and weighted along the outer edge which rotates about said first gear and being rotatably attached to said first connecting bar and said second connecting bar one hundred and eighty (180) degrees from said second gear;
a third connecting bar rotatably attached to said first gear;
a fourth gear in opposite rotational communication with said first gear, being ninety (90) degrees from said second gear and weighted along the outer edge, and being rotatably attached to said third connecting bar;
a fifth gear in opposite rotational communication with said first gear, being 270 degrees from said second gear and weighted along the outer edge, and being rotatably attached to said third connecting bar; and
a third connecting bar rotatably attached to said first gear.

4. A device as in claim 3, further comprising:
a fourth connecting bar rotatably attached to said first gear said first connecting bar and abutting an outer side of said third connecting bar.

5. A device as in claim 1, wherein said first gear rotates in a clockwise direction and said second gear rotates in a counterclock wise direction.

6. A device as in claim 1, further comprising a second drive means for translating centrifugal motion of said first gear to unidirectional motion.

7. A device for conversion of centrifugal force to linear force and motion, said device comprising:
a first gear fixed to a first arm and having a first connecting bar rotatably attached to and abutting the inner side of said first gear;
a second gear in opposite rotational communication with said first gear and weighted along an outer edge and is rotatably attached to and abutting said first connecting bar; and
a first drive means for translating centrifugal motion of said first gear to unidirectional motion.

8. A device as in claim 7, further comprising:
a third gear in opposite rotational communication with said first gear and weighted along the outer edge which rotates about said first gear and being rotatably attached to said first connecting bar one hundred and eighty (180) degrees from said second gear.

9. A device as in claim 7, further comprising:
a third gear in opposite rotational communication with said first gear and weighted along the outer edge and being rotatably attached to said first connecting bar one hundred and eighty (180) degrees from said second gear;
a fourth gear in opposite rotational communication with said first gear and weighted along the outer edge which rotates about said first gear and is rotatably attached to said first connecting bar ninety (90) degrees from said second gear; and
a fifth gear in opposite rotational communication with said first gear and weighted along the outer edge which rotates about said first gear and being rotatably attached to said first connecting bar two hundred and seventy (270) degrees from said second gear.

10. A device as in claim 7, wherein said first gear rotates in a clockwise direction and said second gear rotates in a counterclock wise direction.

11. A device for conversion of centrifugal force to linear force and motion, said device comprising:
a first gear fixed to a first arm and having a first connecting bar rotatably attached to and abutting the inner side of said first gear and a second connecting bar rotatably attached to and abutting the outer side of said first gear;
a second gear in opposite rotational communication with said first gear and weighted along an outer edge and is rotatably attached to and abutting said first connecting bar and said second connecting bar;
a third gear in opposite rotational communication with said first gear and weighted along the outer edge which rotates about said first gear and being rotatably attached to said first connecting bar and said second connecting bar one hundred and eighty (180) degrees from said second gear;
a fourth gear in opposite rotational communication with said first gear, being ninety (90) degrees from said second gear and weighted along the outer edge, and being rotatably attached to said third connecting bar;
a fifth gear in opposite rotational communication with said first gear, being two hundred and seventy (270) degrees from said second gear and weighted along the outer edge, and being rotatably attached to said third connecting bar;
a third connecting bar rotatably attached to said first gear, said fourth gear and said fifth gear; and
a first drive means for translating centrifugal motion of said first gear to unidirectional motion.

12. A device as in claim 11, wherein said first gear rotates in a clockwise direction and said second gear rotates in a counterclock wise direction.

13. A device as in claim 11, further comprising a second drive means for translating centrifugal motion of said first gear to unidirectional motion.
